(19) United States
(12) Patent Application Publication
(10) Pub. No.: US 2025/0274455 A1
(43) Pub. Date: Aug. 28, 2025

(54) METHOD AND SYSTEM OF AUTOMATING AUTHENTICATION AND AUTHORIZATION IN INDUSTRIAL CONTROL SYSTEM OFFLINE ENVIRONMENT

(71) Applicant: SAUDI ARABIAN OIL COMPANY, Dhahran (SA)

(72) Inventors: Abdullah Hatim ALJOHANI, Munarraz (SA); Abdullah Yaseen ALHUSSAIN, Mubarraz (SA); Ahmad Abdulwahab ALHAMAD, Al Jafer (SA)

(73) Assignee: SAUDI ARABIAN OIL COMPANY, Dhahran (SA)

(21) Appl. No.: 18/584,839

(22) Filed: Feb. 22, 2024

(51) Int. Cl. H04L 9/40

(52) U.S. Cl. CPC H04L 63/101

(57) ABSTRACT

A method for automating authentication and authorization of users in an industrial control system (ICS) having an OT network that is air gapped from an IT network of an enterprise system includes querying an active directory of the IT network to obtain a JSON file identifying a first set of one or more users, uploading the JSON file into the OT network, querying an active directory of the OT network to obtain a JSON file identifying a second set of one or more users, comparing, in the OT network, the first set one or more users with the second set of one or more users, and disabling or enabling user access to the OT network based on the comparing.

### FIELD OF THE DISCLOSURE

The present disclosure relates generally to industrial control system (ICS) networks, and, more particularly, to authentication and authorization of users in an ICS network.

### BACKGROUND OF THE DISCLOSURE

An industrial control system (ICS) is an information system that is used to control industrial processes such as manufacturing, product handling, production, and distribution. Industrial control systems can include supervisory control and data acquisition systems used to control geographically dispersed assets, as well as distributed control systems and smaller control systems using programmable logic controllers to control localized processes.

Due to their critical functionality, industrial control systems are typically “air gapped” from the Internet and other networks, protecting them from cyber threats by making them more difficult to remotely access and exploit. For this and other reasons, however, software updates and patches, and access in general, is more cumbersome in ICS, and managing users and accounts is extremely challenging and time consuming. Tight control over ICS accounts is a crucial cybersecurity practice that prevents unauthorized access and insider threats. Due to the nature of the ICS network, deploying IT-based solutions to maintain and manage users' access is not feasible for the isolated and restricted ICS environment. Thus in certain applications, best practice for maintaining cybersecurity control is to rely on signed papers to create authorized accounts, and to conduct regular reviews of these accounts. This approach is very time consuming and is made worse by high employee movement in operational technologies (OT) due to assignments and support for mega projects. This increases the demand for an improved and efficient approach to authenticating and authorizing users in ICS networks.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for automating authentication and authorization of users in an industrial control system (ICS) having an OT network that is air gapped from an IT network of an enterprise system includes querying an active directory of the IT network to obtain a JSON file identifying a first set of one or more users, uploading the JSON file into the OT network, querying an active directory of the OT network to obtain a JSON file identifying a second set of one or more users, comparing, in the OT network, the first set one or more users with the second set of one or more users, and disabling or enabling user access to the OT network based on the comparing.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of an organization having an enterprise system that is shown relative to an ICS of the organization.

FIG. 2 is a flow diagram of a method for configuring a user account in the active directory of an IT network of an enterprise system in accordance with certain embodiments.

FIG. 3 is a flow diagram of a method for automating authentication and authorization of users in an ICS in accordance with certain embodiments.

FIG. 4 is a block diagram of a computer system that may be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to industrial control system (ICS) networks, and, more particularly, to authentication and authorization of users in an ICS network.

In certain embodiments, authentication and authorization in an industrial control system (ICS) environment are managed and automated. Users request access through an IT network. The access may be requested for a specific pre-configured role and once approved, the access will be reflected in an active directory environment hosted by an IT server. A script is run on a regular basis to retrieve the approved users in a JSON format which will be then uploaded in the domain controller server of the offline ICS environment. A software is deployed that requests a system administrator to upload the JSON file. The software retrieves the users identified in the active directory of the ICS and compares them to those from the IT server, providing an indication of the accounts that do not have valid approved access and that can hence be disabled. Moreover, for any valid approved accounts that are not configured in the offline environment, the administrator is alternatively able to configure and enable readily.

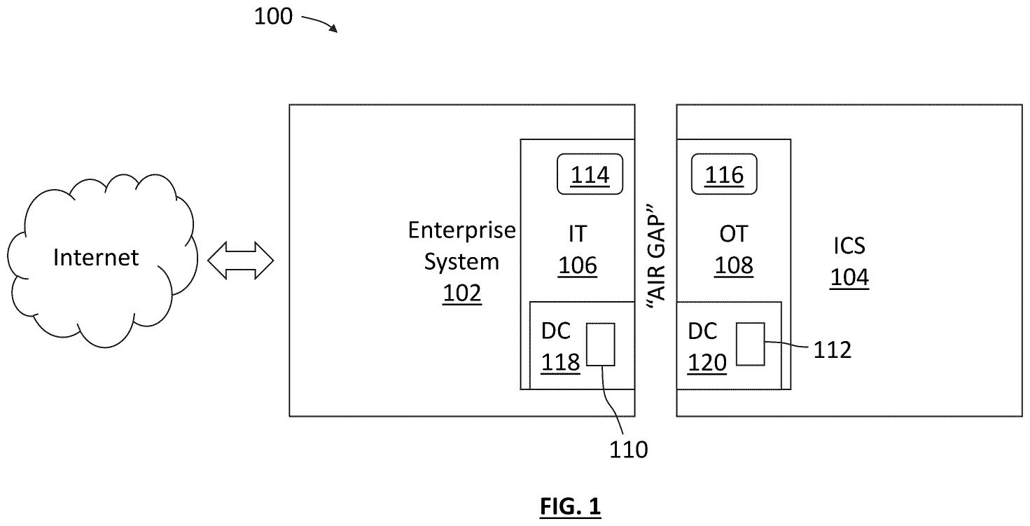

FIG. 1 is a block diagram of an organization 100 in which an enterprise system 102 is shown relative to an ICS 104 of the organization. The organization may be an industrial or manufacturing facility or an oil and gas or mining concern for instance. The enterprise system 102 and ICS 104 are “air gapped” in order to enhance security by isolating the ICS and thereby minimizing access from the Internet-connected enterprise system.

Enterprise system 102 includes an IT (information technology) system 106 that provides the backbone for managing and controlling systems and operations of the organization 100, such as email, finance, payroll, customer information, and so. Similarly, ICS 104 includes an OT (operational technology) system 108 for managing and controlling industrial processes, such as robot motion, valve settings, motor actuation, and so on. Suitable devices such as servers, databases, local and wide area networks, switches, routers and the like (not shown) are provided for these purposes.

IT system 106 and OT system 108 also include respective active directories (ADs) 110 and 112, which may be under the control of respective domain controllers 118 and 120. The active directories may contain critical environment information, including what users and computers are present and who is allowed to access them and for what purposes. They may include user accounts with details such as job title, phone number, username and password, as well as permissions for each individual. The serve to control the activity of the IT environment, ensuring that each person is who they claim to be (authentication), usually by checking the user ID and password they enter, and allowing them to access only the data they are allowed to use (authorization). The active directories simplify control and administration of the networks and enhance organizational security. In addition, users need only authenticate once and can then seamlessly access any resources in the domain for which they're authorized (single sign-on).

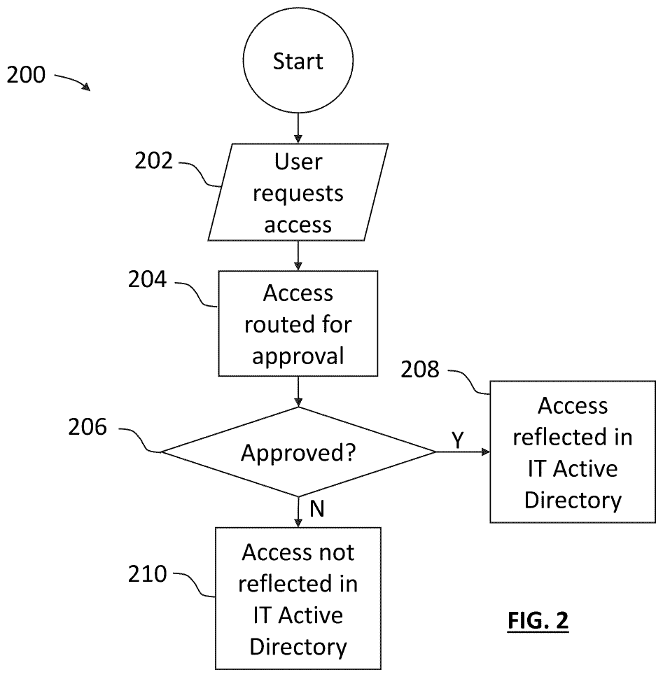

In accordance with certain embodiments, users such as employees of organization 100, who need access to ICS environment 104, first request access to IT network 106. FIG. 2, directed to a method 200 for configuring a user account in the active directory 110 (FIG. 1) of the IT system 106, illustrates this access request step at 202. At 204, the access request is routed for approval, cither automatically in the network IT network 106 or personally to suitable personnel, such as a supervisor of the user. At 206, a determination is made if the access request has been approved. If so, the IT active directory 110 is updated, at 208, to reflect the granted access to the user. Otherwise, at 210, the active directory 110 is not updated to reflect access. Updating the active directory 110 can be performed automatically by the system or by way of the system administrator. Thus in certain embodiments, the users in the updated active directory 110 are all authenticated and authorized users.

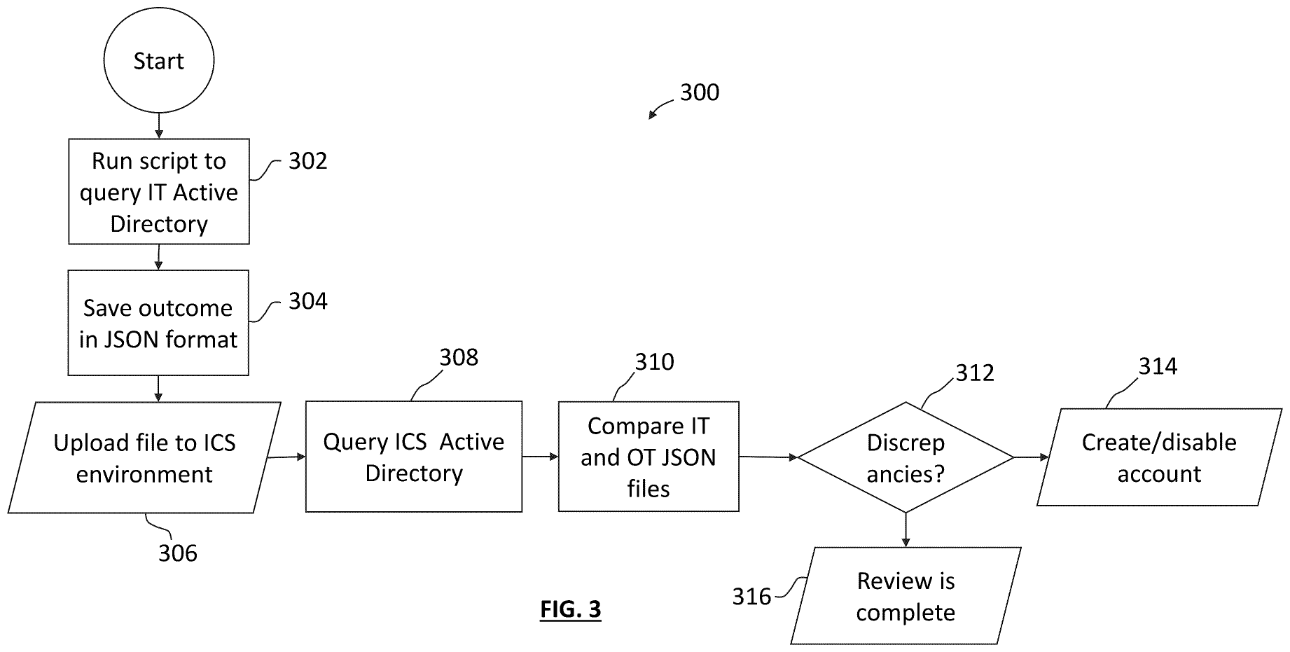

FIG. 3 is directed to a method 300 for automating authentication and authorization of users in an ICS such as ICS 104 in accordance with certain embodiments. At 302, a script 114 is run in the IT system 106 to query the domain controller 118 in IT system 106 to determine the entries in the active directory 110. The script may be executed to query the domain controller frequently on a regular basis. At 304, the outcome of the query is saved in a JSON file, which is a light-weight, text-based, human-readable JavaScript object notation in which entries correspond to the users from the active directory 110. These users may be referred to herein as a first set of one or more users. In certain embodiments, the first set is considered a truth set in that users in the first set are all authenticated and authorized users, as for example assured through implementation of method 200 above to update the active directory 110 with only authenticated and authorized users. At 306, the JSON file is uploaded into a domain controller 120 of the OT network 108 of the offline (i.e., “air-gapped”) ICS environment 104. Software 116 executing in the OT 108 can be used for this purpose to require the upload of the JSON file into the ICS environment 104. The software 116 can then also be executed to query active directory 112 of OT 108, at 308, to compare, at 310, the users who have valid access (the first set of users) identified in the uploaded JSON file associated with active directory 110 with those in the active directory 112. The comparison can for instance be based on the users' login ID, which is common in both the IT network 106 and OT network 108. The comparison can be of JSON files, wherein the outcome of the query of the active directory 112 of OT environment 108 is converted to a JSON file by the software in order to compare it with the uploaded JSON file. The users in the active directory 112 of OT 108 may be referred to herein as the second set of users. If, as a result of the comparison, a discrepancy is found, at 312, then the administrator will have the option, at 314, of disabling second set users who do not have approved access; or granting access to these second set users; or creating accounts for first set users in OT network 108. The software 116 will enable the administrator to disable or create users by a simple click on a displayed button in a user interface (not shown) for instance. In certain embodiments, the software 116 will notify the administrator if the user exists solely in an organizational unit (OU) or if the user has a high privileged account, to prevent disrupting an ongoing operation. For instance, if there is only one user in Organizational Unit (OU) the software should not disable the account without warning the administrator that there is no other user that can do the job. In this case, the account should not be disabled even if access is not renewed without making sure that this will not impact the ongoing operation.

In certain embodiments, if the user is disabled or created utilizing this solution a remark may be written to the domain controller 120 of the OT network 108 to indicate the action taken and the time of the action. Adding these remarks will help with accountability since it will indicate who configured the accounts. If no discrepancy is found then the review is complete at 316.

While, for purposes of simplicity of explanation, the example methods of FIGS. 2 and 3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

By implementing the above solutions, advantages such as reducing any human errors from occurring are realized since the only human input required is to upload the JSON file and the remaining tasks will be handled predominantly by the software. Furthermore, the approaches described herein will enhance accountability by logging all activities and maintaining time stamped logs in a local file.

Managing users in ICS environments is always a challenge since it is isolated and restricted, and the advantageous aspects of the solutions described herein include utilizing an IT server which will be used to govern the access requests and then implementing these requests in the ICS domain controller without the need of configuring them manually whenever an account is expired or employee movement is taking place. This automated solution will ensure that all the user's access is approved and it will keep track of any changes on a frequent basis without the need of conducting timely user reviews that can open doors to human errors and waste considerable manhours.

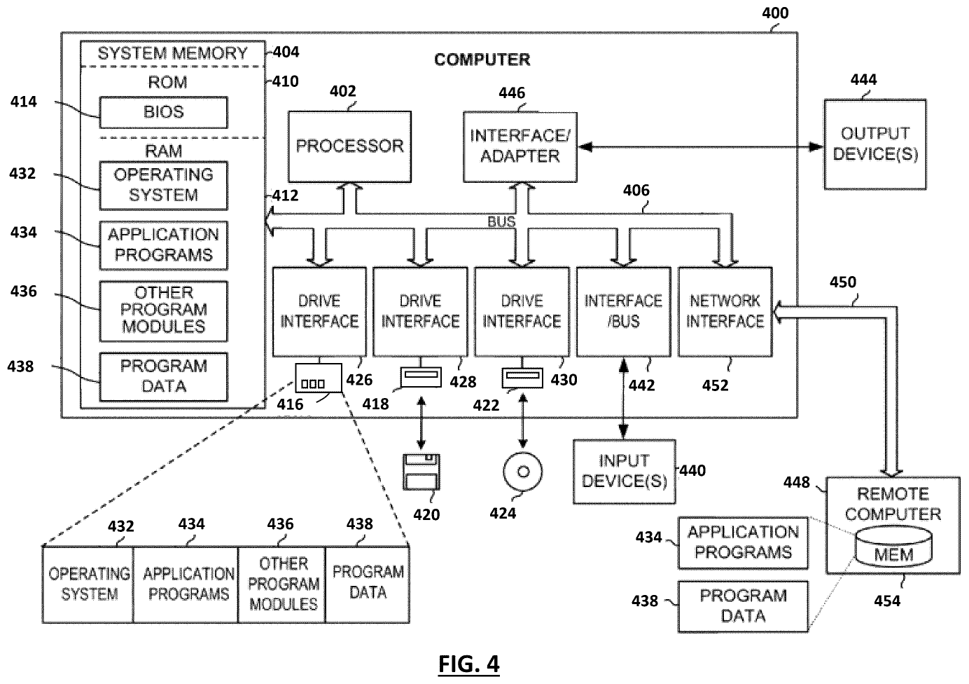

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard. FIG. 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. System memory 404 can include volatile (e.g. RAM, DRAM, SDRAM. Double Data Rate (DDR) RAM, etc.) and non-volatile (e.g. Flash, NAND, etc.) memory. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422. e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 410, including operating system 432, one or more application programs 434, other program modules 436, and program data 438. In some examples, the application programs 434 can include programs to execute methods 200 and 300 or portions thereof, and script and/or software discussed above, and the program data 438 can include the active directors containing first and second sets of one or more users.

A user may enter commands and information into computer system 400 through one or more input devices 440, such as a pointing device (e.g., a mouse, touch screen), keyboard, microphone, joystick, game pad, scanner, and the like. For instance, the user can employ input device 440 to edit or modify active directory 110 and/or 112. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 400 can be connected to the local network through a network interface or adapter 452. When used in a WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 400, or portions thereof, may be stored in a remote memory storage device 454.

Embodiments disclosed herein include:

A. A method for automating authentication and authorization of users in an industrial control system (ICS) having an OT network that is air gapped from an IT network of an enterprise system, the method comprising:
querying an active directory of the IT network to obtain a JSON file identifying a first set of one or more users;
uploading the JSON file into the OT network;
querying an active directory of the OT network to obtain a JSON file identifying a second set of one or more users;
comparing, in the OT network, the first set one or more users with the second set of one or more users; and
disabling or enabling user access to the OT network based on the comparing.

Embodiment A may have one or more of the following additional elements in any combination: Element 1: the first set of one or more users comprises a truth set containing only authenticated and authorized users. Element 2: querying the active directory of the IT network is conducted by executing a script to query a domain controller in the IT network. Element 3: the script is executed on a regular basis. Element 4: the comparison is based on user login ID. Element 5: enabling or disabling user access comprises disabling second set users who do not have approved access; or granting access to second set users; or creating accounts for first set users in the OT network. Element 6: enabling or disabling user access is conducted through software executing in the OT network. Element 7: uploading is conducted through software executing in the OT network. Element 8: the software conducts querying the active directory of the OT network.

By way of non-limiting example, exemplary combinations applicable to A through C include: Element 1 with Element 2; Element 2 with Element 4; Element 2 with Element 7; Element 4 with Element 6; and Element 5 with Element 7.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method for automating authentication and authorization of users in an industrial control system (ICS) having an OT network that is air gapped from an IT network of an enterprise system, the method comprising:
querying an active directory of the IT network to obtain a JSON file identifying a first set of one or more users;
uploading the JSON file into the OT network;
querying an active directory of the OT network to obtain a JSON file identifying a second set of one or more users;
comparing, in the OT network, the first set one or more users with the second set of one or more users; and
disabling or enabling user access to the OT network based on the comparing.

2. The method of claim 1, wherein the first set of one or more users comprises a truth set containing only authenticated and authorized users.

3. The method of claim 1, wherein querying the active directory of the IT network is conducted by executing a script to query a domain controller in the IT network.

4. The method of claim 3, wherein the script is executed on a regular basis.

5. The method of claim 1, wherein the comparison is based on user login ID.

6. The method of claim 1, wherein enabling or disabling user access comprises disabling second set users who do not have approved access; or granting access to second set users; or creating accounts for first set users in the OT network.

7. The method of claim 6, wherein enabling or disabling user access is conducted through software executing in the OT network.

8. The method of claim 1, wherein uploading is conducted through software executing in the OT network.

9. The method of claim 8, wherein the software conducts querying the active directory of the OT network.
